(19) United States
(12) Patent Application Publication
(10) Pub. No.: US 2022/0019960 A1
(43) Pub. Date: Jan. 20, 2022

(54) UniTOS Universal Transportation Operating System

(71) Applicant: Custody Chain LLC, Round Rock, TX (US)

(72) Inventors: Stewart A. Skomra, Round Rock, TX (US); Maureen M. Frazier, Austin, TX (US)

(21) Appl. No.: 17/378,517

(22) Filed: Jul. 16, 2021

Related U.S. Application Data
(60) Provisional application No. 63/053,202, filed on Jul. 17, 2020.

(51) Int. Cl. G06Q 10/08

(52) U.S. Cl. CPC G06Q 10/083

(57) ABSTRACT

A Universal Transportation Operating System (UniTOS) with Next-Best Move provides for the application of packet-switching and defragmentation algorithms to the determination of optimal time and location for delivery and/or receipt of both intangible and tangible payloads.

### CROSS-REFERENCE TO RELATED APPLICATION

The present application claims benefit of 63/053,202 filed Jul. 17, 2020, which is incorporated herein by reference in its entirety and for all purposes.

This application is related to the following commonly-owned patents and publications, each of which is incorporated herein by reference for all purposes as if expressly set forth herein:

U.S. Pat. No. 9,456,302 B2, issued Sep. 27, 2016;

U.S. Pat. No. 8,149,850 B2, issued Apr. 3, 2012;

U.S. Pat. No. 8,595,302 B2, issued Nov. 26, 2013;

U.S. Pat. No. 7,945,675 B2, issued May 17, 2011;

U.S. Publication No. 2009/0117879 A1, published May 7, 2009;

U.S. Publication No. 2005/0076198 A1, published Apr. 7, 2005.

### FIELD

The technology herein relates to optimizing transport efficiency, and more particularly to the transport of shipping containers through a shipping network.

### BACKGROUND & SUMMARY

The movement of intermodal containerized cargo to/from ocean-going transport, to/from port terminal, to/from cranes, trucks, and railcars historically has involved myriad information technology (IT) systems that, while integrating with one another at their inputs and outputs, have been purpose built for optimizing the scope of their custody domain.

For example, there are typically separate IT systems serving the movement of containers from ships to docks by Rail Mounted Gantry Cranes (RMG) that extend no further than the unloading and placement of inbound containers from a container ship. A separate Transportation Operating System, or TOS, that coordinates activities within the facility where the container ship inbound containers have been stored may then be employed to serve the operation of retrieving containers from an intermediate container stack storage location for delivery to an inbound truck or railcar. The inbound truck, operated by contractors or the ultimate receiver of the containerized cargo, is directed by a TMS (Transportation Management System) which may be independent of myriad instances of TMS offerings used by the many inbound trucks or railcars.

The entry to the intermodal terminal is typically controlled through ingate operations that may be staffed by security and inspection personnel or operated through a ingress-controlled kiosk through which truck drivers must report their arrival details including the company for which they are retrieving or delivering a container load along with the container number associated with their specific load. The gate system will provide a message to inform both intermodal site personnel as well as the TOS work order system that a planned order pickup or drop off activity has passed through the ingate.

The TOS serves to control the movement and storage of various types of cargo in and around a container terminal or port, enabling better use of assets, along with planning and scheduling labor and workflow through the facility. Transportation Operating Systems often utilize a host of technologies such as internet, EDI (Electronic Data Interchange) processing, mobile computers, wireless WAN-LAN-PANs (Wide-Area, Local-Area, and Personal-Area Networks), camera systems for OCR (Optical Character Recognition), vision systems for inspections along with Radio-frequency identification (RFID) to efficiently monitor the flow of products in, out and around the terminal with work order data typically provided through batch data synchronization with a central/site-specific planning-scheduling-dispatch database.

With the increasing volume of freight moving by ocean-going container ships and intermodal container railroad consists, intermodal terminal operations have implemented many overlapping information systems for computerized procedures to manage cargo, machines and people within the facility in an attempt to enable a seamless link to efficiently and effectively manage the facility serving functions including:

Shipping: Terminals requiring various types of ship transport Container terminals using Containerization for LO-LO (lift on lift off) operations such as these require plans for efficiently loading and unloading Container ships docked within their Terminal. A port using RO-RO (roll on roll off) ships require plans for efficiently loading automobiles, trucks, semi-trailer trucks, trailers or railroad cars that are driven on and off the ship on their own wheels.

Rail: Terminals that require the arrival and departure of cargo on trains such as container trains or bulk cargo.

Road: Handle the receival and release of Cargo for transshipment from other modes of transport or storage.

Yard management: Creating Shipping list or keeping track of Warehouse levels. Tracking machine moves around the terminal.

Invoicing/Reporting: Invoicing and providing reports for internal and external use.

Inventory: Keeping track of Inventory and storing its movements.

Cargo Type: Various types of cargo can be managed dependent of terminal type. Containers, Logs, Bulk Cargo. The ability to pick and pack containers.

TOS Communications Services: An individual Intermodal Terminal requires the TOS to enable communications services with multiple interdependent stakeholders including: Terminal Operators, Freight Forwarders, Shipping Lines and/or Shipping Agents, Container Operators, Port Authorities, and Customs Office.

### BRIEF DESCRIPTION OF THE DRAWINGS

FIG. 1 shows an example shipping operation and system.

FIG. 2A shows an example Single Source and Single Recipient.

FIG. 2B depicts a planned drop-off exchange from a Source that is traveling to the exchange location to be then picked up by a Recipient from the Exchange location.

FIG. 2C depicts a many-to-many pick-up embodiment.

FIG. 2D depicts a many-to-many drop-off embodiment.

FIG. 3A shows an example complete asset life cycle management.

FIG. 3B shows an example asset intelligence management with a web service API.

FIG. 3C shows example intercommunication between the web service API and mixed network connection management.

FIGS. 4A, 4B show example Chassis Landing Gear Down and Up respectively.

FIG. 5 shows example hostler or yard trucks.

FIG. 6 shows an example reach stacker.

FIGS. 7A-7C show an example hostler yard truck and chassis unhooked, hooked and hooked with load, respectively.

FIGS. 8A and 8B show example ledgers.

FIG. 8C shows a flowchart of program control steps performed by the processor of FIG. 9 to perform example automated negotiation and exchange of work and work-related resources.

FIG. 9 shows an example electronic processing system.

FIG. 9A is a flowchart of program control steps performed by the processor of FIG. 9 to determine optimized routing of containers.

### DETAILED DESCRIPTION OF EXAMPLE NON-LIMITING EMBODIMENTS

The example non-limiting technology herein provides a “UniTOS”—a Universal Transportation Operating System—that enables automated control of one or more or more independently operating machines including coordination and sharing of tasks in the performance of work that each of the individual operating machines had previously been or is currently being or will dynamically be assigned.

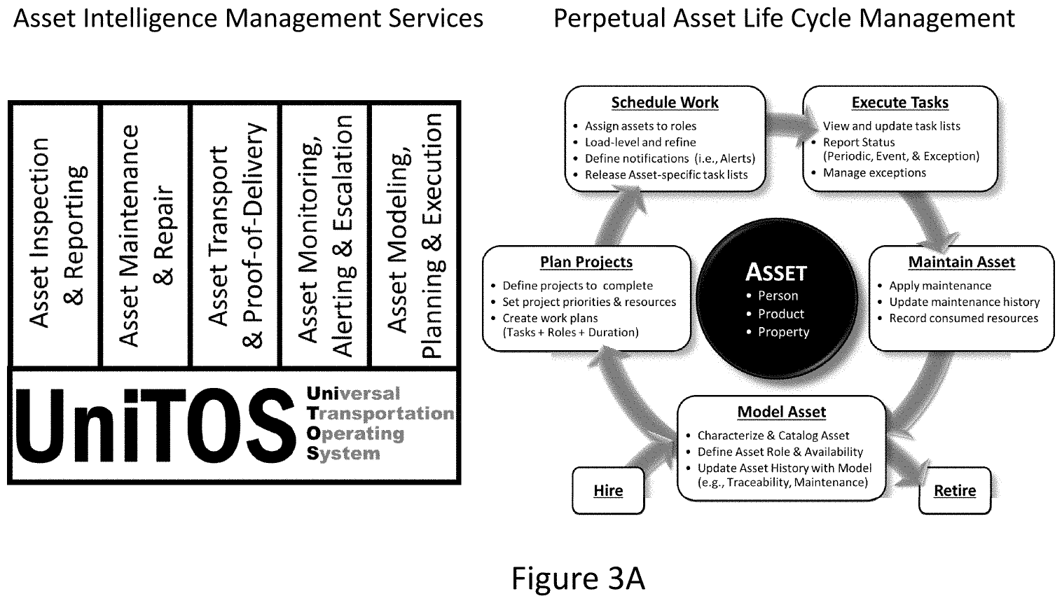

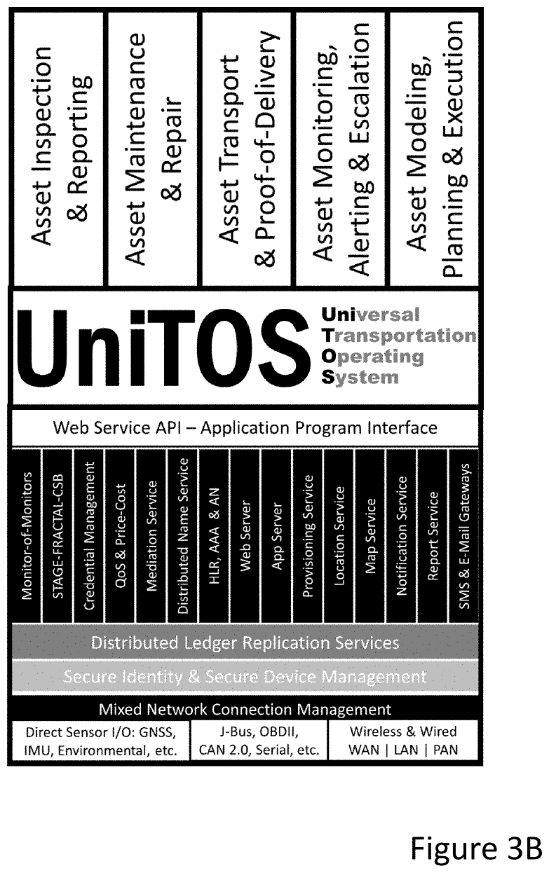

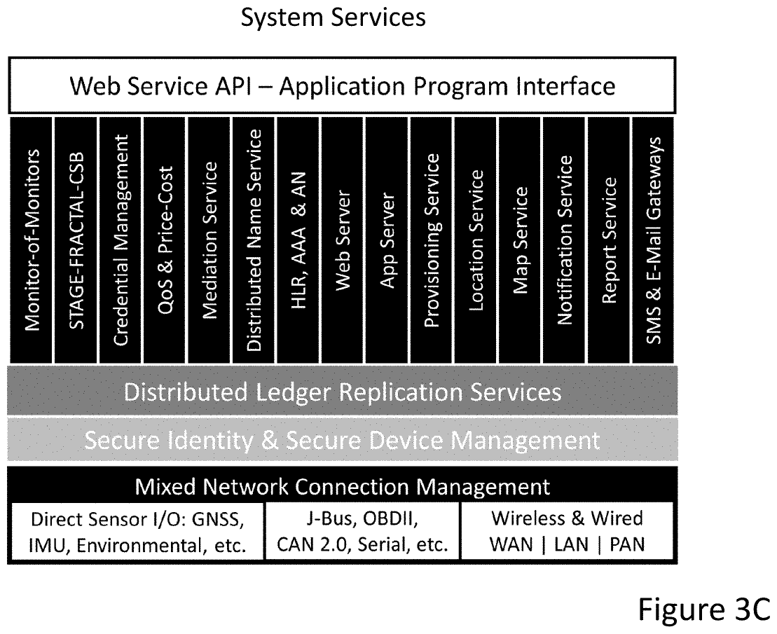

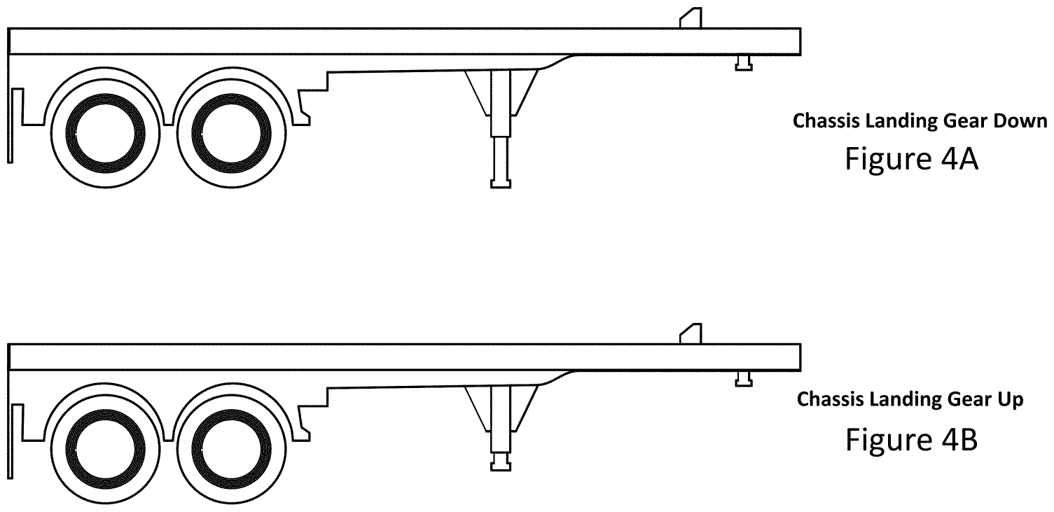

In one embodiment, UniTOS provides a suite of dynamically programmable machine automation (i.e. algorithms, protocols, and procedures) addressing optimized performance in the execution of planned work—where work may be determined as the product of force applied over distance traveled—by machines regardless of the physical environment within which the machines are operated (e.g., On/Off Road, Marine, Air, Rail, other). See for example FIG. 3A.

In one embodiment, UniTOS employs continuous reconciliation of the measured accomplishment of work against the expected outcome of the plan that produced the work instructions so that automated steps for adjustment of future planned work may be introduced to return the measured work outcome to meet its original design tolerance.

For purpose herein, a “machine” may be any non-biological entity (e.g. tractor, crane, humanoid robot, et cetera). An example UniTOS embodiment that serves to illustrate the features of example embodiments is the movement of containerized cargo through mixed transportation modes including movement on ocean-going container ships through transfer to trucks and/or railroad trains with ultimate delivery to the destination, where the contents of the container are unloaded producing an empty container for use in return shipments. The methodology may also involve biological entities (i.e., humans or animals) in some embodiments.

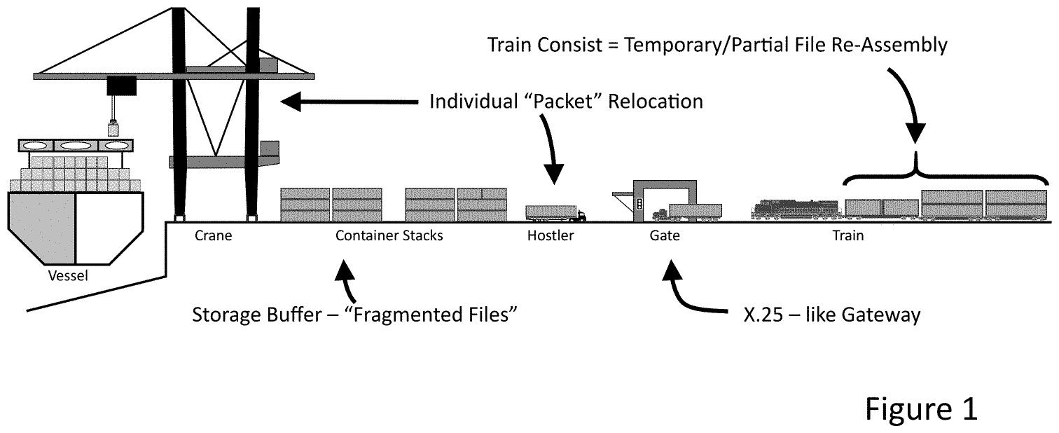

UniTOS—Universal Transportation Operating System in one embodiment may comprise a programmable suite of machine automation (i.e. algorithms, protocols, and procedures) addressing optimized performance of work by machines regardless of the physical environment within which the machines are operated (e.g., On/Off Road, Marine, Air, Rail, other) in conducting work. An example of UniTOS operation shown in FIGS. 1 and FIGS. 3A-3C is for coordinating and controlling, the application of ITE (Intermodal Terminal Equipment) machines to optimize movement of Containerized Cargo throughout Intermodal Freight Terminals, within constraints of time, space, and target operating efficiencies.

In one embodiment, UniTOS is a self-propagating and self-modifying program employing dynamic delegation of the very same UniTOS machine readable program from a first node to a second node. Upon receiving initial provisioning elements of UniTOS from the first node, the second node employs the newly established services to complete provisioning of its own replica of the UniTOS suite. The second node may, in turn, execute UniTOS services to perform work that may be delegated through the sharing of UniTOS programmed and programmable instructions. UniTOS enables closed-loop feedback of planned execution actual results to effect changes in subsequent planning-scheduling-execution, thereby minimizing overall work expended to accomplish a desired outcome. “Work”, in its most basic form, is defined as Force multiplied by Distance and a UniTOS collaborative coordinated constellation of nodes distributes the responsibility for performance of work among member nodes with the work subdivided in multiples of the least commonly divisible payload.

### Example UniTOS Transport System

FIG. 1 shows an example terminal operation including berths, a yard and gates. FIG. 1 shows on the left-hand side a berth area at which is berthed a vessel such as a container ship that has standard intermodal containers on board. An intermodal container, often called a shipping container, is a large standardized shipping container, designed and built for intermodal freight transport, meaning these containers can be used across different modes of transport—from ship to rail to truck—without unloading and reloading their cargo. See Lewandowski, Krzysztof, “Growth in the Size of Unit Loads and Shipping Containers from Antique to WWI”, 29 (8-9): 451-478, Packaging Technology and Science. (2016); doi:10.1002/pts.2231. ISSN 1099-1522. Such intermodal containers are primarily used to store and transport materials and products efficiently and securely in the global containerized intermodal freight transport system. Intermodal containers exist in many types and a number of standardized sizes, but most of the global container fleet are so-called “dry freight” or “general purpose” containers—namely durable closed steel boxes, mostly 8 feet (2.4 m) wide and of either 20 or 40 feet (6.1 or 12.2 m) standard length. The common heights are 8 feet 6 inches (2.6 m) and 9 feet 6 inches (2.9 m)—the latter are known as High Cube or Hi-Cube (HC) containers. See https://en.wikipedia.org/wiki/Intermodal_container (retrieved Jul. 15, 2021).

Standardized Geometries: For movement of Intermodal Containerized Cargo, the smallest common dimension of Payload is the TEU ISO shipping container. While ISO Twenty-foot Equivalent Unit (TEU) has dimensions of 20′ length, 8′ wide, 8.5′ tall, roughly ⅔rd of all ISO shipping containers are 2 TEU having 40′ length with same width and heights as the 1 TEU. While UniTOS may apply to any coordinated work, the movement of ISO standard-sized shipping containers and their contents represents an opportunity for collaboration among assets for the transport of these containers over common carriers—Marine, Rail, Tractor-Trailer (see FIG. 1)—with each ITE asset and mode of conveyance sized and instrumented for handling and securing these common geometry containers.

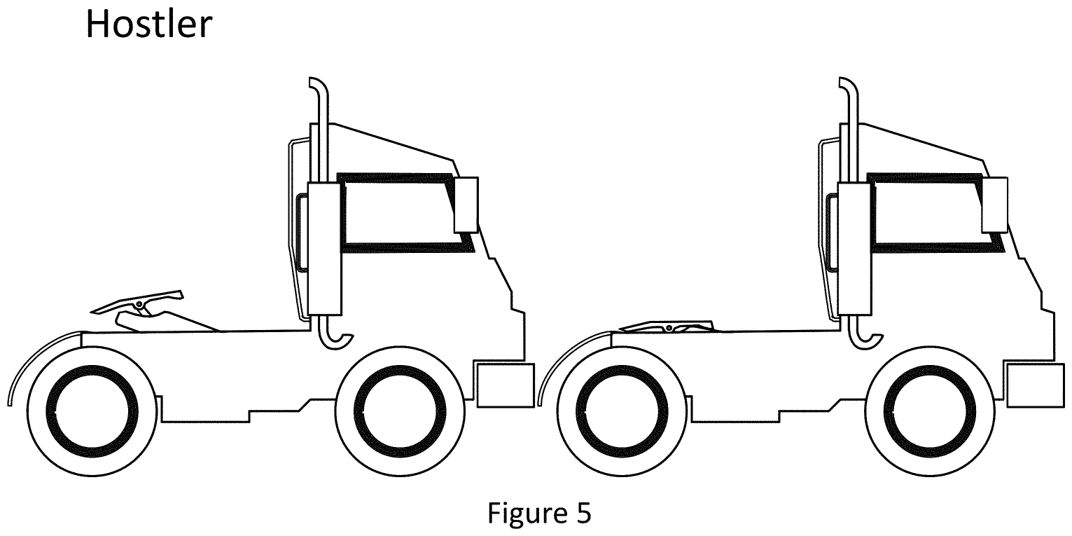

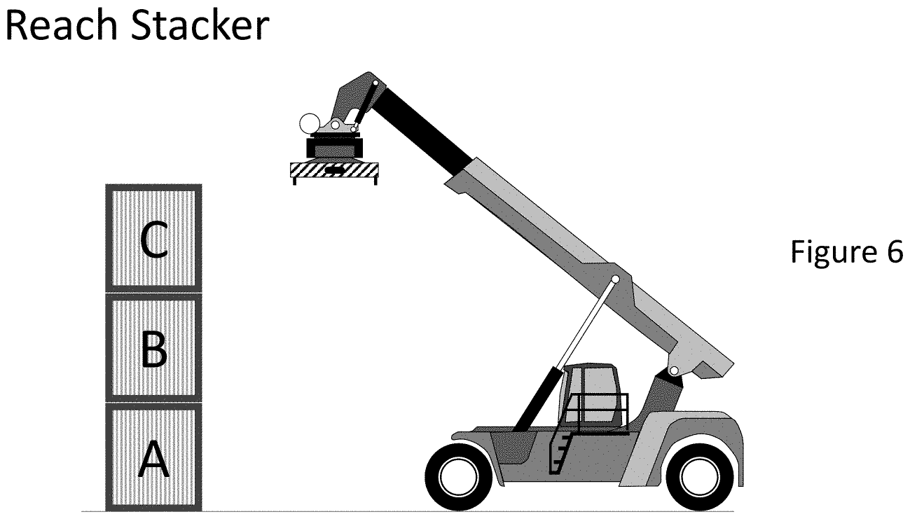

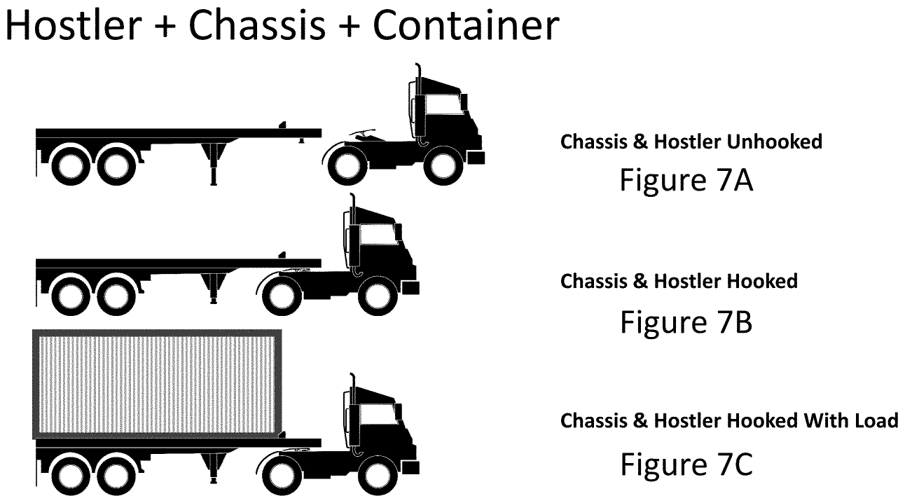

FIG. 1 shows a crane in the berth area that unloads the containers from the vessel and stacks the containers in the yard. See e.g., https://www.marineinsight.com/ports/container-gantry-crane-construction-and-operation. The gantry crane can pick up one or multiple containers at a time from the vessel and place them in a stack in the yard—often in five-high stacks. A different crane called a rubber tire gantry (RTG) (not shown) or toploaders (see FIG. 6) then typically removes particular containers from the stack and places them on a vehicle—either a hostler vehicle (see FIG. 5) operated by the yard which moves the containers from the container stacks to other locations in the yard, or in some cases directly onto a truck or other vehicle that will transport the container to its final destination.

The gates and associated support provides checking and security to ensure that containers are routed to their proper destinations and do not leave the yard except with proper authorization and permission. For example, the gate may be used to collect and scan requests for containers by incoming trucks or other vehicles, ensure that a requested containers have already been removed from the vessel and placed in the yard, have been released by the steamship line, has cleared customs, are free from any US Department of Agriculture or other regulatory holds such as for unpaid fees such as demurrage, storage or traffic mitigation fees, and also that a truck requesting the container has proper credentials/authorization and a current appointment for picking up that particular container. The gate may be used to authenticate the truck and its driver to ensure such authorization is present. and may track that the container is leaving the yard on which vehicle with what documentation and manifests such that the yard is no longer responsible for the container. The gate may comprise multiple checkpoints to manage different kinds of workflow.

FIG. 1 further shows that in certain cases, rail tracks can be connected to the yard and containers may be loaded by the hostlers (see FIG. 5), toploaders or other yard equipment onto a train rather than a truck for transport. A single train may transport a large number of containers.

The yard is also capable of unloading containers from one vessel and loading them onto another vessel in the berth area, e.g., to provide multi-leg sea journeys for containers to reach their final port destination.

FIG. 1 further shows that the entire process can occur in reverse—that is, containers can arrive by train or truck, are driven through the gate, stacked, and then loaded by the crane onto a container vessel for transport to another port. Trucks and trains can bring in full containers for shipping out and leave with full containers for transport to final destinations. The yard also typically has facilities for removing and storing empty containers so that trucks arriving in the yard to pick up a new container can offload their old empty container for reuse.

The same yard can also handle non-containerized cargo such as pipes, steel coils, fungible materials such as coal, salt, grain, etc. The yard may also provide a container freight station that strips cargo from a container and stuffs cargo into a container to thereby facilitate amalgamation of goods from diverse sources into a common container for shipping. Some terminals may also have warehouses to help store and manage goods. See e.g., https://www.youtube.com/watch?v=Zx9OuWLVrHw

### TOS Management System

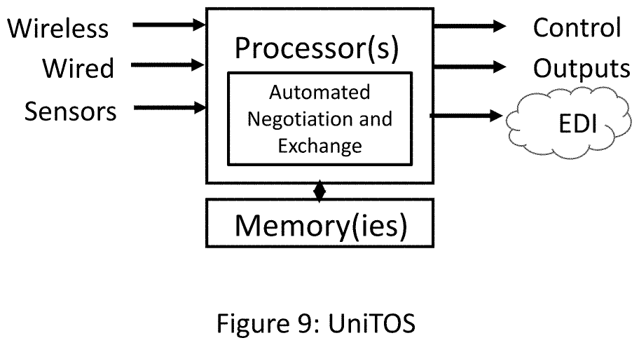

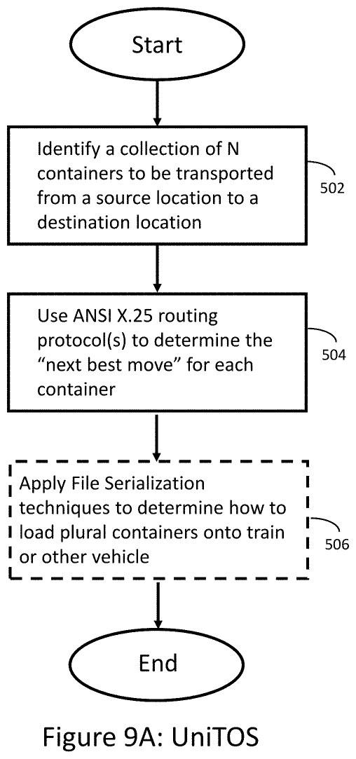

FIG. 9 shows an example non-limiting UniTOS management system used to manage the operations of the terminal shown in FIG. 1. The main function of the UniTOS management system is to track goods as they come into the terminal via the berths, train or gates; are stored in the yard, and leave the terminal via the berths, train or gates. Such tracking involves tracking operations such as:
Terminal inventory
Gate movements
Vessel movements
Crane movements
Truck visits
Train visits
Demurrage and detention
Yard utilization
Warehouse inventory and utilization
Freight station operation
Other.

The TOS is typically event driven and is supported by wireless (and/or wired) communication with all of the various machines operating in the terminal (vessels, cranes, toploaders, hostlers, trucks, trains, containers, etc.) Various tracking technology such as RFID, WiFi, 2D and 3D bar code scanning, photographic pattern recognition, GPS, and other sensors etc. may be used to track the positions and movements objects (including but not limited to containers) within the terminal. The UniTOS is typically able to track each container by ID and other information and constantly maintains information concerning position and status (and in some cases other information such as temperature of refrigerator containers) of containers in the terminal. The UniTOS can also track productivity statistics such as truck turnaround time, crane unloading times, etc. The TOS is also used to automatically invoice customers for services the terminal provides. The UniTOS also provides an electronic data interchange interface allowing different customers (e.g., shipping lines, trucking lines, trail lines, etc.) to access information relevant to them. The UniTOS may also be used to directly or indirectly control automated machines such as robotic cranes, hostlers, toploaders, warehouses and other yard machines. While FIG. 9 shows a centralized computing architecture, distributed computing or cloudbased computing architectures can be used instead or in addition.

UniTOS delivers information technology automation through three major facilities:
Chain-of-Custody Asset Life-Cycle Management combined with, Offset Lead-Time Planning-Scheduling-Execution through automation of, Direct-Cost Managerial Accounting Distributed Ledger.
UniTOS Asset Intelligence Management (AIM) is implemented through:
   Asset Focus. Treating everything/Every ‘Thing’ as an Asset including People, Product, Property (tangible and intangible) along with investment of Time, Talen, and Treasure for Assets employed in Combinations to generate resultant Assets
   ‘Packet’ Routing and ‘File’ Defragmentation. Treating Source (e.g., Factory) output as a Serialization-to-Deserialization process in constructing physical ‘packets’ (i.e., Shipper Containers/Trailers) and Destination as a Deserialization-Serialization process of deconstructing ‘packets’ (i.e., Unloading Containers/Trailers and Delivering Cargo). Intermodal Shipping Containers standard geometries enable use of extremely high performance, low-cost, packet-based network routing, and ‘next-best-move’ ITE-Asset tailored container placement through defragmentation algorithms,
   Direct-Cost Accounting. Measure of Work as a minimum of the mechanical Force X Distance, accumulating Work that must be applied for movement of an Asset from one Spot to any other Spot (including the penalty of additional Work imposed by the need to move other Assets before the Asset-of-Interest is able to be moved.
Automated Distributed Ledger. Dynamically establishing, maintaining, and retiring Charts of Accounts (i.e., Debit-Credit Ledger) with Planned Values serving as Debits and Actual Values as Credits and maintaining that all output must equal all inputs (e.g., Asset #1+Work=Asset #2+Waste). Use of this Distributed Ledger for maintaining the Cascaded-Distributed Task Lists and facilitating the Percolated Actual Results with automatic Variance Analysis checked against acceptable Tolerance Value violation generating a dynamic Re-Plan Exception Alert.
Role & Actor. Separation of the Role that may be fulfilled by an Asset-type and the Identity of the specific Asset performing the Role. For example, an individual Commercial-Vehicle Licensed Person (an ‘Actor’) may be qualified and authorized to work as a Driver (the ‘Role’) for multiple employing Companies at the same time. The separation of Role and Actor enables Rough-Cut Capacity Planning, Load-Leveling and Analysis common to Multivariate Optimization techniques (e.g., Project Planning fusion with Enterprise Resource Planning)

UniTOS AIM—As FIG. 3B shows, Universal Transportation Operating System Asset Intelligence Management may be implemented fully on an individual Edge Node serving an individual Asset, on a Host Computer serving multiple Assets through Proxies, in Premise, Cloud, and Hybrid-Cloud environments. The FIG. 3B architecture of FIG. 9 shows that the processor(s) may perform any or all of the following and/or be configured to provide the following:
Monitor of monitors;
Stage fractal CSB;
Credential management;
Quality of service and price—cost calculation;
Mediation service;
Distributed name service;
Home location register, Authentication Authorization Accounting, and Authentication and Authorization
Web and/or app server;
Provisioning service;
Location service;
Map service;
Notification service;
Report service;
SMS and email gateways.

As FIG. 3C shows, UniTOS Core system components addressed throughout implementation include:
Secure Identity/Asset Enrollment Services
Secure Communications Services
Distributed Information Model Construct
Distributed ledger replication services
Reactive JavaScript HMI
Progressive JavaScript Services
Edge Node software
Distribute Data Synchronization
Alert Processing Services
E-Mail and SMS Generation Services
Short Message Service Gateway
Web Services (RESTful & Reactive)
Web Service API

FIG. 3C also shows how the FIG. 9 structure can provide mixed network connection management for a variety of communications interfaces such as direct sensor inputs/outputs (e.g., cameras, GNSS, IMUs, environmental, etc.); various busses such as vehicle J-Bus, OBDII, CAN 2.0, serial, parallel, etc.; and wireless and wired connections (e.g., PAN, WAN, LAN, WiFi, 60 GHz IEEE 802.11ad, etc.)

### Packet Switching Optimizations

In accordance with some embodiments herein, for routing purposes, containers are routed in ways similar to packets of a packet switched network. Technologies used to optimize the transport, route and manage packets over a packet switched network may thus be used to optimize the transport, route and management of containers. Examples of such packet switching optimizations for X.25 data packets may be found for example in Rahbar, Quality of Service in Optical Packet Switched Networks (IEEE Press Series on Information and Communication Networks Security 1st Edition 2015); Blokdyk, Packet Switched Network A Complete Guide (2020 Edition); Barnett, Packet Switched Networks Theory and Practice (1988); and Sosinsky, Networking Bible (Wiley 2009), each incorporated herein by reference.

The result is a network consisting of myriad interconnections, heterogeneous connecting points, serving mixed modes of transportation of physical containers that may be modelled and routed using management, information, and telecommunication sciences in a manner similar to that which is used for the deserialization and serialization of sequences of binary digits (bits) along with packetizing and depacketizing groups of binary digits and the subsequent delivery of the sequence of binary digits and storage of same in a manner that is optimal for subsequent retrieval for further use within an interconnected information technology ecosystem.

Thus for example, FIG. 1 further shows that the container stacks in the yard can be analogized to fragmented files on a storage device; that the crane and hostler may be analogized to individual packet relocation; that the gate acts like an X.25 or other gateway; and that loading containers on the train is analogized to temporary/partial file re-assembly.

In the context of retrieving digital files, the performance of retrieving and conveying a digital file from its storage location (e.g. SATA—Serial Advanced Technology Attachment computer disk driver) and deliver to its recipient (e.g. CPU—Central Processor) is accomplished by the storage system maintaining an index of the overall storage system contents which it follows for accessing the appropriate binary digits and placing them in the proper order for delivery. When exchanging the serialized file between two computing and storage systems, the assemblies of serialized data subdivided into packets are each treated as individual payloads transmitted over what may be a branching and interconnecting mesh of individual point-to-point serial links providing myriad paths for individual packets to traverse the distance separating the originating source from the recipient. See for example Anderson, SATA Storage Technology (Mindshare Press 2007) (ISBN-13: 978-0977087815).

In one embodiment, each shipping container represents an electronic communications protocol packet, and techniques such as algorithms and communications routing protocols are used to route the shipping containers as if they were being routed over a packet switched digital communications network such as the Internet. Shipping containers bear resemblance to communications information packets for example in that they each provide an encapsulation of a payload that is to be transported across time and space. Like a communications packet, a shipping container can be thought of as comprising a “header” (i.e., an information source on or associated with the shipping container that uniquely or semi-uniquely identifies the shipping container and may supply additional information identifying characteristics of the shipping container and/or the desired transport of the container, including but not limited to destination address) and a “payload” (in the case of a shipping container, the payload is the physical contents of the container). Containers differ from communications packets in that they they cannot be copied, sent one-to-many, or repeated. However, a wide variety of existing of packet routing optimization techniques can be used to route shipping containers.

Treating ISO Containers as Packets: In more detail, the FIG. 9 UniTOS considers each ISO shipping container to serve as a packet of a unit-container load or an assemblage of a larger overall payload (e.g. 10,000 Televisions) that is to be conveyed from one Source (e.g. Television Factory) to one or more recipients (e.g. Television Retailers). Whether a digital file (i.e. continuous series of bits) is transmitted as individual bits or packets of bits, the optimal route over which the disassembled file constituent parts travel employs packet switching data network protocols such as ANSI X.25. ANSI X.25 protocol is mature and well known throughout the information processing and telecommunication technology industries. See for example, The Basics Book of X.25 Packet Switching, 2d Ed. (Motorola Codex) (Addison-Wesley 1992). By applying ANSI X.25 protocols to the routing of individual ISO shipping containers, a highly efficient and timely optimized routing for each container may be accomplished that balances the capacity of any individual path (e.g. number of road lanes available, amount of utilization, speed of throughput, et cetera) with the preferred priority of arrival of the ISO shipping containers for their loading to a freight train or ocean-going container ship.

### Treating Freight Train Consists as Assembled Files

A Train ‘Consist’ is the physical makeup of the fully assembled series of Railroad Cars (i.e. Flat Cars, Auto Carrier Cars, Box Cars, Gondolas, Tank Cars, Well Cars, et cetera) along with the Cargo that is contained within or on the individual Railroad Cars. The “consist” is thus a lineup or sequence of railroad carriages or cars, with or without a locomotive, that form a unit. In a similar manner to the treatment of ISO shipping containers as X.25 packets, these same ‘packets’ may be treated as elements of a complete file that has been Deserialized, Packetized and will subsequently be De-Packetized and Reserialized. The ‘file’ may be considered as the Finished Goods Inventory having been produced at the end of an originating Manufacturer (e.g. Television Factory) which is producing the Finished Goods for fulfillment of customer Orders (e.g. Television Retailers). Each ‘Order’ may be a subset of an overall Finished Goods comprising the ‘file’ that is to be transmitted from the Factory to one or more final destinations. The ‘file’ is Deserialized by breaking the total into separate Unit Loads that may each have one or more of the Finished Good items that is bound for one or more Destinations by loading and unloading from ISO Container or other Load-Carrying Conveyance (e.g. Finished Automobiles that are loaded on road Transport Vehicles within Car Carriers that are, in-turn, unloaded and reloaded to Railroad Car Carrier. See FIG. 9A.

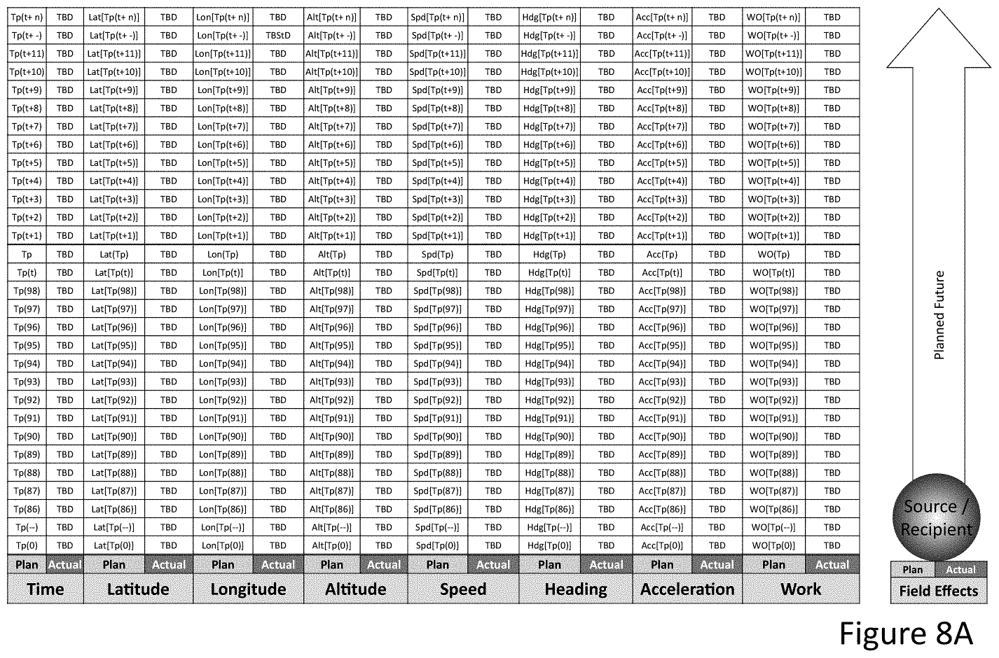

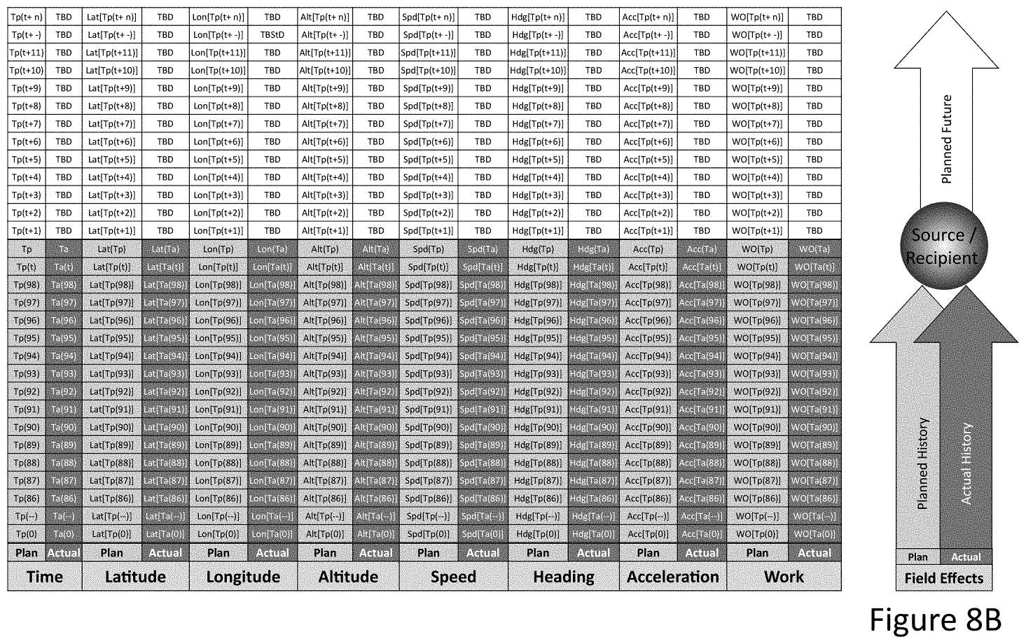

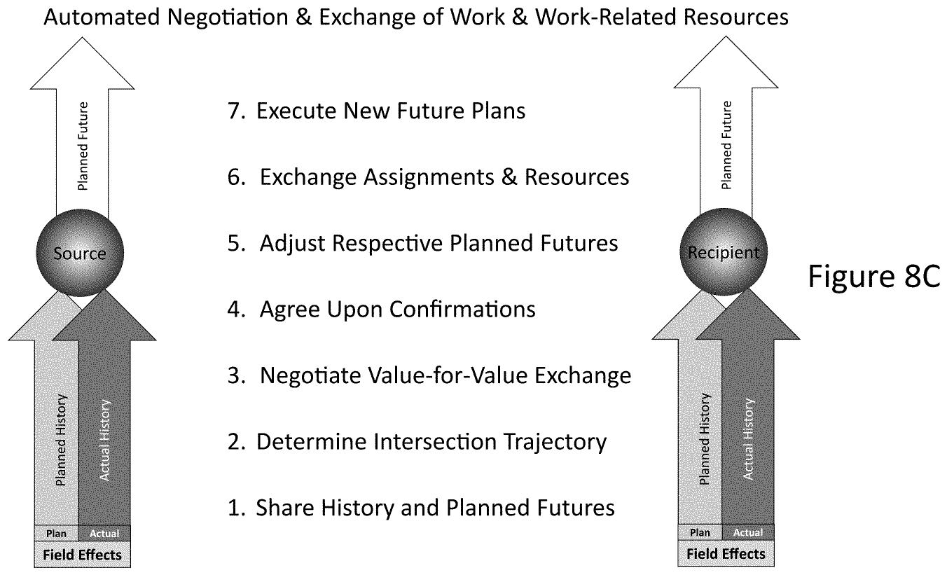

ISO Containers are loaded to Flat Cars or Well Cars that become part of the Freight Train Consist. The Train Consist, itself, may be treated as a ‘file’ that is Depacketized and Reserialized to build the Train Consist ‘file’ (e.g. Multiple ISO Containers may be stacked on a Well Car). UniTOS, by treating Assets the same regardless of the nature of the Asset, maintains a ‘Planned’ Consist (for example in the case where the Asset=an Assembled Freight Train) and also provides a corresponding ‘Actual’ ledger account. The ‘Plan-versus-Actual’ Variance is cleared through a conventional Double-Entry Bookkeeping Clearing Account that serves as feedback for continuous adjustment of future Plans continuously driving toward minimizing the Variance altogether. See discussion below in connection with FIGS. 8A-8C.

With the Consist considered to be a serialized ‘file’ (both Plan and Actual) and the Cargo arriving at an Intermodal loading/unloading facility/site as discrete ‘packets’ from originating ‘files’, UniTOS employs file defragmentation algorithms to identify that optimal location for delivery of the inbound (with respect to the Freight Train loading and unloading) cargo and for the pickup of outbound cargo by site both Road Transport Vehicles and also by the ITE—Intermodal Terminal Equipment (e.g. Gantry Cranes, Reach Stackers, Side Loaders, Hostlers/Yard Spotters, Straddle Carriers, et al). UniTOS defragmentation algorithms may execute at each of these Edge Nodes or may be performed by proxy Assets (e.g. Cloud/Hybrid-Cloud/Premise-based Computing) so that at any point in time, each Asset will be provided its Next-Best Move (NBM). The NBM defragmentation algorithm works against the characterization of each Asset to determine the cost (as in measure of work) for the Asset operation in performing its movement of ISO Containers and other shipping Assets (e.g. Trailers) within the span of operation of the individual Asset. NBM works to ensure that the minimum cost or amount of work will be required for accomplishing the movement of the Cargo with a balanced trade-off against achieving the building of the ‘Planned Freight Train Consist’ schedule.

Since the Overall Intermodal Facility may be treated as one Asset within which there are many individual Assets, NBM may be considered at each individual Asset level and at groups of Asset levels allowing for the addition or removal of Assets (e.g. Trucks Arriving to Drop off or Pick Up Cargo) on a continuously flowing basis. This ability to provide a ‘drill-down’ and ‘drill-up’ view of NBM enables visibility to extend outward and downstream to the intermediate and final destinations and upstream to the intermediate and initial origins. This visibility will allow any Asset level Plan-versus-Actual Variance analysis to be performed for the closed-loop feedback.

Automated Facility Access Operation and Management: UniTOS provides for elimination of unnecessary and overlapping functions historically implemented at Intermodal Freight facilities implemented to ensure that the proper Inbound and Outbound activities are performed. This aspect of UniTOS is referred to as Automated Gate System (AGS). AGS, with respect to the X.25 Packet-Switching aspect of UniTOS, may be considered a Bridge or Router node through which the Packet-Transfer would be optimized. Again, there will be a ‘Planned-versus-Actual’ Inbound and Outbound ledger maintained with respect to the instances of AGS for the purposes of optimizing routing of Inbound and Outbound activities. The AGS provides for:
Driver Interaction—AGS implements a “Virtual Kiosk” with the same UniTOS AGS driver registration, in-gate, and out-gate software solution operating on the driver Smart Phone, Tablet, and Desktop devices in addition to the physical AGS Kiosk.
Pre-Notification: Taking advantage of its customer driver mobile devices, the UniTOS AGS architecture enables the Railroad, Intermodal Operations, and individual drivers that are performing facility Inbound and Outbound work (e.g. Work Order-Scheduled Trips), to have better visibility of readiness.
Security “Gateless”-Gate: The “Virtual Kiosk” enables the removal of the barrier arm lift gates when the Crash Gate is implemented. Having the same driver interface offering serving both the physical kiosk and the driver mobile device ensures that the right drivers are not kept waiting.
AI-enabled Kiosk: Artificial Intelligence (AI) engine integrated with the imagery capture, Crash Gate operation, and Kiosk.
System-Solution: UniTOS AGS enables the integration with Railroad and Shipper (e.g. Manufacturer, Retailer, et al) systems to extend existing information systems such as legacy planning, scheduling, dispatch, inspection, maintenance, repair, billing, et cetera) automation with and through the UniTOS AGS system operation; streamlining the time to driver issue resolution while capitalizing on advancements in the Wireless and Smart Phone ecosystems.

### Example Use Case—Movement of a Parcel Po

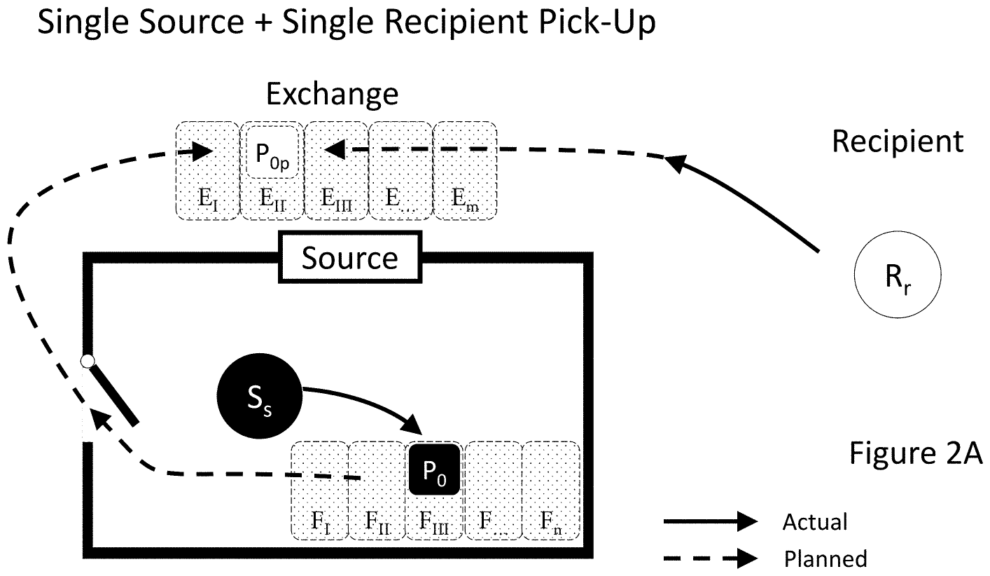

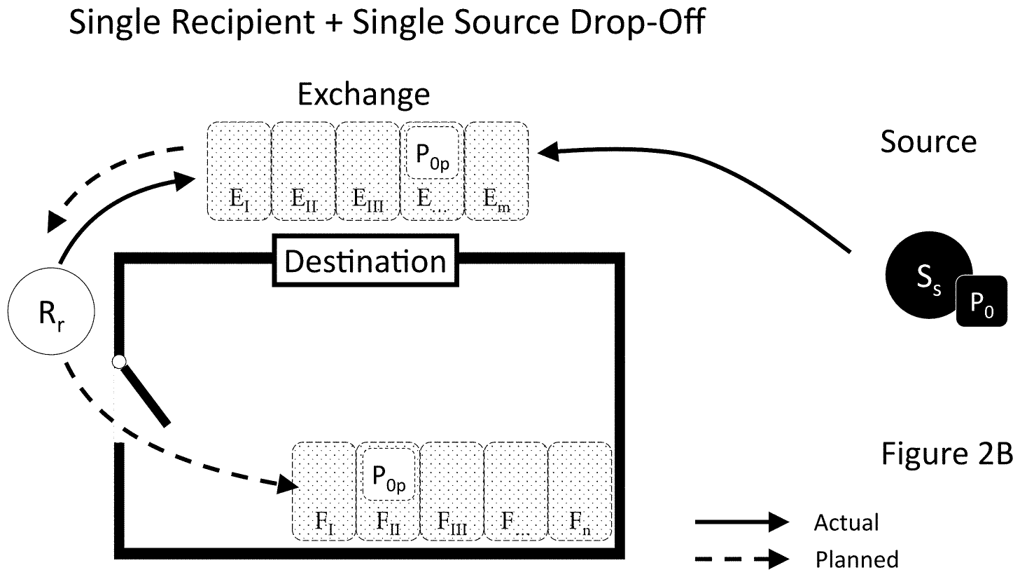

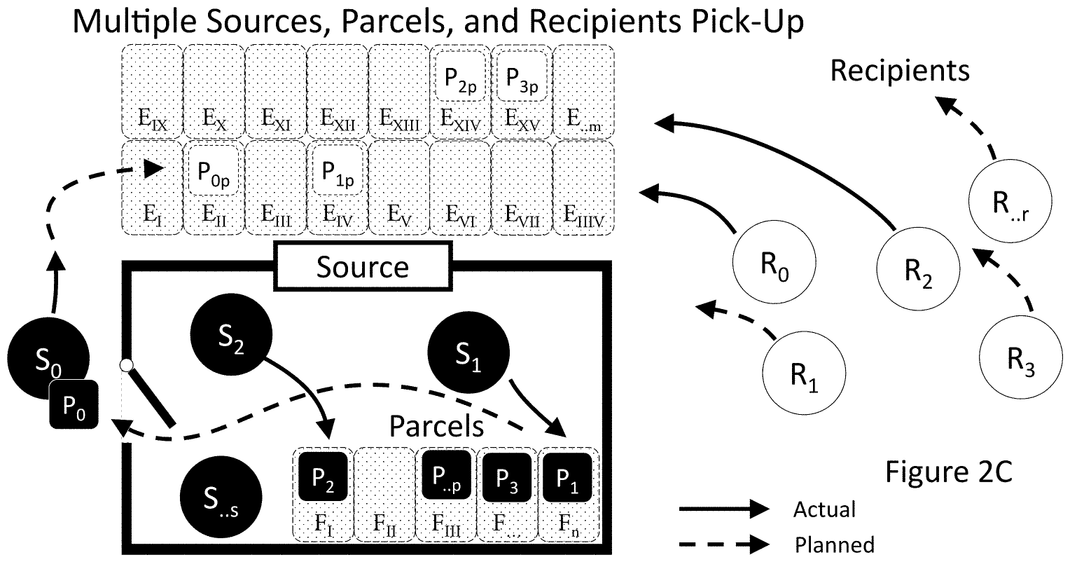

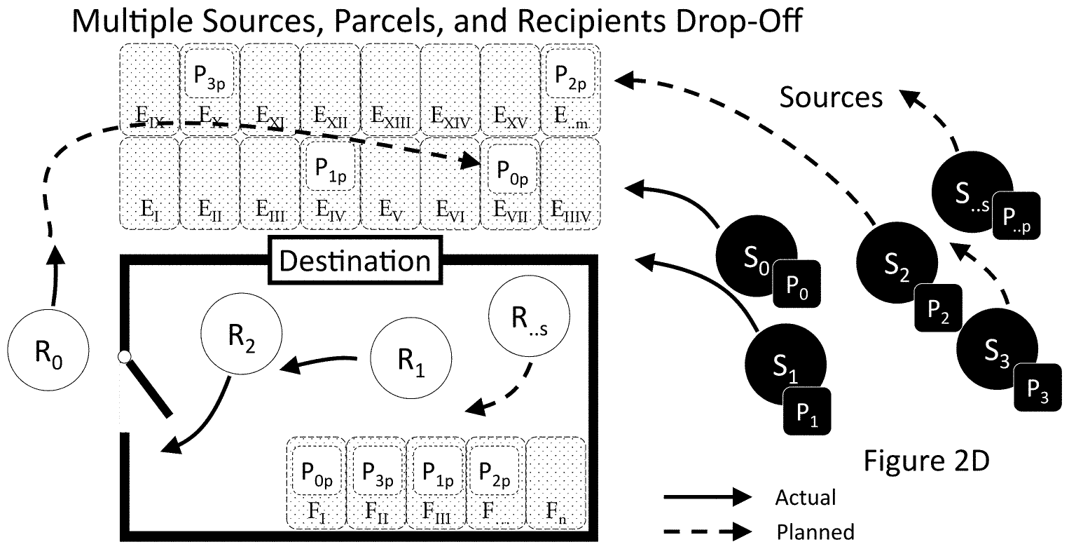

FIGS. 2A-2D depict an example of assigned Work as the movement by a Source (Ss) of a Parcel (Po) from a Finished Good inventory within the Source pickup/drop-off spots within an intermediate Exchange location (Em).

Within each of Source location and Exchange location there may be any number of unique sub-locations enumerated through subscript roman numerals shown in FIG. 2A.

While the exchange of Po from Source Ss to Recipient Rr may be accomplished directly in a synchronous manner, differences in planned arrival and actual arrival times by Ss and Rr require that the specific exchange location Em be communicated between Ss and Rr. The planned Em exchange location is maintained (for example as the planned exchange location EII depicted in the diagram as the location of planned P0 or P0p) until a change in custody of Po sets the actual Em location. The solid arrows in FIG. 2A depict the Actual movements while the dashed arrows depict the Planned movement. Adjustments in the Planned Future resulting from exchanges and replanning events may change the yet-to-be executed trajectories and timings of the movements.

FIG. 2B depicts a planned drop-off exchange from a Source that is traveling to the exchange location to be then picked up by a Recipient from the Exchange location.

FIG. 2C depicts a many-to-many pick-up embodiment.

FIG. 2D depicts a many-to-many drop-off embodiment.

As FIG. 3A indicates, UniTOS enables closed-loop feedback of actual results from planned execution to effect changes in subsequent planning-scheduling-execution thereby minimizing overall Work expended to accomplish a desired outcome. A UniTOS system solution distributes the performance of Work among member nodes subdivided in multiples of the least commonly divisible payload.

UniTOS System Services (FIG. 3C) takes advantage of the scalable architecture and integrated flexible solutions catalyzed by the explosive Smart Phone industry and its dramatic underlying improvements in sensor, semiconductor, and wireless communications ingredients. A strength is inherent integration capability—the entire information technology solution has been architected, developed, and delivered through state-of-the-art and standards-based integration elements (e.g., Reactive Information Base, Responsive—Progressive JavaScript, HTML5, RESTful Web Services, etc.). Integration enables quick introduction of image capture, sensor, machine, and customer-specific data in a manner that will scale to support future CN needs.

In the ISO Container Transportation embodiment, storage and retrieval of containers within a stack of containers is a last-in first-out (LIFO) inventory management function.

FIG. 6 shows that as additional Boxes are added to an inventory location, the amount of Work required to retrieve earlier inventoried Boxes increases by the amount of work required to remove the later inventoried asset. For example, (FIG. 6) if a Box B is placed on Box A, and a third Box C is placed on Box B, the planned/potential Work (WAP) to retrieve A increases by the Work required to remove C and to remove B.

In addition to repacketizing (e.g., disassembly of a ‘File’ from an ISO Container Stack with reassembly of same to a Train Consist), this fluctuating Work value (WAP′) is used by UniTOS to determine the sequence in which Boxes are to be placed and stacked. Therefore, the fluctuating potential Work associated with Box A, WAP′=WAP+WBP″+WCP″ where the (″) components of Box C and Box B-related Work are a minimum of the amount of Work necessary to free Box A and less than or equal to the planned Work for Box C and Box B.

In other words, the magnitude of the planned Work to move Box A is the original Box A plan plus the Work to either move Box C and Box B out of the way of Box A to the maximum of completing the Work related to Box C, Box B, before completing the full Work associated with Box A.

In the ISO Intermodal Containerized Cargo Transportation embodiment, a manufacturer finished goods inventory is treated as a file or collection of files. Each file represents a unique UniTOS Work Order (WO). A WO may be an assembly of multipole WOs. The movement of finished goods into ISO Shipping Containers (Box, Boxes) represents the packetization and de-packetizing process as one or multiple WO may be contained in an individual Box as well as a WO may span multiple Boxes.

The routing of the individual Box is performed using X.25 packet switching protocol with each UniTOS edge node capable of determining the sequence in which Boxes need to move through the network. The priority of Boxes may be determined based on the cumulative Work ΣW=Wm+WT+WO.

### Example Chart of Accounts

In one embodiment shown in FIG. 8A, UniTOS implements a chart-of-accounts for each defined Asset (whether Person, Product, or Property) against which magnitudes of monitored attributes (e.g., Speed, Heading, Acceleration) are continuously recorded indexed against the Time and Location (i.e., Latitude, Longitude, and Altitude) at which the measurement of attribute values is captured.

As FIG. 8B shows, this chart-of-accounts is of a double-entry bookkeeping type with Credits (i.e., Actual Values) are recorded against Debits (i.e., Planned Values) and the difference between Actual and Planned defined as the Variance. Attributes also include explicit states (e.g., ‘On Duty’) and assignments (e.g., Work Order) and attributes may be used to derive additional state information (e.g., ‘Maintenance Due’).

UniTOS Asset Monitoring, Planning, & Execution continuously monitors variance and triggers replanning when variance meets or exceeds asset design tolerance.

Work for any individual asset is defined, at a minimum, as the classical mechanical definition WM=Force×Distance. Work may also include additional non-physics components that include innovation WT=Time×Talent and the opportunity foregone by enlisting additional assets in the Work of the subject asset, WO=Time×Property. ‘Talent’ is the proficiency of, and ‘Property’ is the definable intrinsic value of additional assets employed in the achievement of the subject asset's Work. ΣW=WM+WT+WO

Work is memorialized as digital currency. The digital currency is stored within the UniTOS charts-of-accounts with data synchronized using distributed ledger technology such as Blockchain Hyperledger Fabric. The extent of the replication propagation is moderated by the potential intersection in space and time of assets with one another.

### Exchange of Planned Work and Work-Related Resources between Assets

FIG. 8C shows that with continuous distributed ledger data replication services, UniTOS enables individual asset replanning to include the exchange of planned Work and Work-related resources between assets that are performing Work.

The negotiation and exchange (see FIG. 8C) is initiated when the UniTOS instance that is running in support of each asset determines that future planned Work is to be reduced or increased.

Required resources for planned Work to be performed by a Source (FIG. 8C) asset are exchanged with a Recipient asset in the consummation of the exchange. Both the Recipient and the Source planned futures will now be affected by the Work exchange and adjusted accordingly. In all instances, the original planned future by time is retained so that the historical Work and magnitude of all effects to which an asset is subjected may be incrementally added to the planned future to bring the updated planned future more closely into alignment with the resultant actual.

With Work memorialized as digital currency, Settlement of Payment for Work performed by individual Assets throughout the life of the Work Order is accomplished automatically through the contract replication.

UniTOS tenets include the definition of Work, recording Time & Location and magnitude of Work performed, attribution of individual Work components by responsible asset, continuous update of the Work required to relocate an asset, and the ability to dynamically exchange Work.

All patents and publications cited herein are incorporated by reference.

1. A transportation operating system for execution on at least one processor operatively coupled to non-transitory memory, the at least one processor being configured by instructions stored in the non-transitory memory to perform operations comprising:
receiving an identification of a plurality of shipping containers; and
applying data packet routing techniques to route the shipping containers.

2. The transportation operating system of claim 1 wherein the data packet routing techniques comprise ANSI X.25 packet routing protocols.

3. The transportation operating system of claim 1 wherein the data packet routing techniques comprise data storage serialization and/or deserialization techniques.

4. A transportation operating system for execution on at least one processor operatively coupled to non-transitory memory, the at least one processor being configured by instructions stored in the non-transitory memory to perform operations comprising:
Modelling assets including characterizing and cataloging assets, defining asset role and availability, updating asset history with model;
Defining projects to complete, setting project priorities and resources, and creating work plans;
Assigning assets to roles, load-leveling and refining, defining notifications, and releasing asset-specific task lists;
Enabling viewing and updating of task lists, reporting status, and managing exceptions; and
Applying maintenance, updating maintenance history and recording consumed resources.

5. The transportation operating system of claim 4 wherein the transportation operating system further comprises at least three of the following:
Monitor of monitors;
Stage fractal CSB;
Credential management;
Quality of service and price—cost calculation;
Mediation service;
Distributed name service;
Home location register'
Authentication Authorization Accounting and/or Authentication and Authorization;
Web and/or app server;
Provisioning service;
Location service;
Map service;
Notification service;
Report service;
SMS and email gateways.

6. The transportation operating system of claim 4 further comprising a communications interface that manages mixed connections including direct sensor input/output, bus communications, wireless communications and wired communications.

7. A transportation operating system for execution on at least one processor operatively coupled to non-transitory memory, the at least one processor being configured by instructions stored in the non-transitory memory to perform operations comprising:
Sharing history and planned futures,
Determining intersection trajectory,
Negotiating value-for-value exchange,
Agree upon confirmations,
Adjust respective planned futures,
Exchange assignments and resources, and
Execute new future plans.

8. The transportation operating system of claim 7 further comprising controlling robotic hostlers and/or gantry cranes and/or top loading cranes to move shipping containers.
